(19) United States
(12) Patent Application Publication
(10) Pub. No.: US 2020/0135150 A1
(43) Pub. Date: Apr. 30, 2020

(54) INFORMATION PROCESSING DEVICE, INFORMATION PROCESSING METHOD, AND PROGRAM

(71) Applicant: SONY CORPORATION, TOKYO (JP)

(72) Inventors: KENJI SUGIHARA, KANAGAWA (JP); MARI SAITO, KANAGAWA (JP)

(21) Appl. No.: 16/493,455

(22) PCT Filed: Feb. 21, 2018
(86) PCT No.: PCT/JP2018/006107

§ 371 Date: Sep. 12, 2019

(30) Foreign Application Priority Data
Apr. 26, 2017 (JP) 2017-087429

(51) Int. Cl. G09G 5/36; G09G 5/02; G09G 5/10

(52) U.S. Cl. CPC G09G 5/36; G09G 5/02; G09G 2320/0686; G09G 2354/00; G09G 2340/0407; G09G 5/10

(57) ABSTRACT

An information processing device, an information processing method, and a program capable of dynamically changing visibility of a user's view are proposed. An information processing device including: a position of interest estimation unit configured to estimate a position of interest of a user; and a visibility control unit configured to perform visibility control to gradually reduce visibility of a second view opposite to a first view of the user corresponding to the position of interest such that the visibility of the second view of the user becomes lower than visibility of the first view.

### TECHNICAL FIELD

The present disclosure relates to an information processing device, an information processing method, and a program.

### BACKGROUND ART

Conventionally, various techniques related to virtual reality (VR) and augmented reality (AR) have been developed. With VR, a user can watch, for example, a video of a three-dimensional virtual space generated by a computer with highly realistic feeling. Furthermore, with AR, various types of information (for example, a virtual object and the like) can be presented to a user in association with a position of the user in a real space.

Furthermore, various techniques to control display in accordance with a detection result of a user's sight line have also been proposed. For example, Patent Document 1 described below describes a technique to display a display object in an area determined to have high detection accuracy of a sight line on a display screen.

### CITATION LIST

### Patent Document

Patent Document 1: Japanese Patent Application Laid-Open No. 2015-152938

### SUMMARY OF THE INVENTION

### Problems to be Solved by the Invention

As described above, in the technique described in Patent Document 1, control according to the detection accuracy of a sight line is performed. Meanwhile, there is still room for improvement in dynamically changing visibility of a user's view.

Therefore, the present disclosure proposes a novel, improved information processing device, an information processing method, and a program that can dynamically change visibility of a user's view.

### Solutions to Problems

The present disclosure provides an information processing device including: a position of interest estimation unit configured to estimate a position of interest of a user; and a visibility control unit configured to perform visibility control to gradually reduce visibility of a second view opposite to a first view of the user corresponding to the position of interest such that the visibility of the second view of the user becomes lower than visibility of the first view.

Furthermore, the present disclosure provides an information processing method including: estimating a position of interest of a user; and performing, by a processor, visibility control to gradually reduce visibility of a second view opposite to a first view of the user corresponding to the position of interest such that the visibility of the second view of the user becomes lower than visibility of the first view.

Furthermore, the present disclosure provides a program for causing a computer to function as: a position of interest estimation unit configured to estimate a position of interest of a user; and a visibility control unit configured to perform visibility control to gradually reduce visibility of a second view opposite to a first view of the user corresponding to the position of interest such that the visibility of the second view of the user becomes lower than visibility of the first view.

### Effects of the Invention

As described above, the present disclosure can improve user experience by dynamically changing the visibility of the user's view. Note that advantageous effects described here are not necessarily restrictive, and any of the effects described in the present disclosure may be applied.

### BRIEF DESCRIPTION OF DRAWINGS

FIG. 1 is an explanatory diagram showing an exemplary configuration of an information processing system according to an embodiment of the present disclosure.

FIG. 2 is a diagram showing an example of a captured image of an eye when a user is looking forward and an exemplary diagram showing a relationship between a view of the user and a collision range of a sight line.

FIG. 3A is an exemplary diagram showing a relationship between a true collision range in the view of the user, a detection error range of the collision range, and a size of a virtual object in a situation shown in FIG. 2.

FIG. 3B is a diagram showing an example of a positional relationship between the true collision range in the view of the user, the detection error range of the collision range, and the virtual object in the situation shown in FIG. 2.

FIG. 4 is a diagram showing an example of the captured image of the eye when the user is looking at a peripheral portion of the view, and an exemplary diagram showing the relationship between the view of the user and the collision range of the sight line.

FIG. 5A is a diagram showing an example of a positional relationship between the true collision range in the view of the user, the detection error range of the collision range, and the virtual object in a situation shown in FIG. 4.

FIG. 5B is a diagram showing an example of a positional relationship between the true collision range in the view of the user, the detection error range of the collision range, and the virtual object in the situation shown in FIG. 4.

FIG. 6 is a diagram showing an example of a relationship between the view of the user and the collision range of the sight line in a case where a scan range is expanded in the situation shown in FIG. 4.

FIG. 7 is a diagram showing an example of a positional relationship between the true collision range in the view of the user, the detection error range of the collision range, and the virtual object in a situation shown in FIG. 6.

FIG. 8 is a functional block diagram showing an exemplary configuration of a head mounted display (HMD) 10 according to the embodiment.

FIG. 9A is a view showing a modified example of a display mode of a display range corresponding to a second view of the user while a video of VR content is displayed on the HMD 10.

FIG. 9B is a view showing a modified example of the display mode of the display range corresponding to the second view of the user while the video of VR content is displayed on the HMD 10.

FIG. 9C is a view showing a modified example of the display mode of the display range corresponding to the second view of the user while the video of VR content is displayed on the HMD 10.

FIG. 10A is a view showing an example of the captured image of the eye captured when (or immediately before or after) the video shown in FIG. 9A is displayed.

FIG. 10B is a view showing an example of the captured image of the eye captured when (or immediately before or after) the video shown in FIG. 9B is displayed.

FIG. 10C is a view showing an example of the captured image of the eye captured when (or immediately before or after) the video shown in FIG. 9C is displayed.

FIG. 11 is a flowchart showing part of a processing flow according to the embodiment.

FIG. 12 is a flowchart showing part of the processing flow according to the embodiment.

FIG. 13 is an explanatory diagram showing an exemplary hardware configuration of the HMD 10 according to the embodiment.

### MODE FOR CARRYING OUT THE INVENTION

A preferred embodiment of the present disclosure will be described in detail below with reference to the accompanying drawings. Note that in the present specification and the drawings, components having substantially the same functional configuration are denoted with the same reference symbol, and redundant description thereof will be omitted.

Furthermore, in the present specification and the drawings, a plurality of components having substantially the same functional configuration is distinguished by assigning a different letter of the alphabet after the same reference symbol in some cases. For example, a plurality of components having substantially the same functional configuration is distinguished like an HMD 10a and an HMD 10b as necessary. However, in a case where it is unnecessary to particularly distinguish each of the plurality of components having substantially the same functional configuration, only the same reference symbol is assigned. For example, in a case where it is unnecessary to particularly distinguish the HMD 10a and the HMD 10b, the components are referred to as just an HMD 10.

Furthermore, the “mode for carrying out the invention” will be described in order of items shown below.

1. Configuration of information processing system

2. Detailed description of embodiment

3. Hardware configuration

4. Modifications

### 1. CONFIGURATION OF INFORMATION PROCESSING SYSTEM

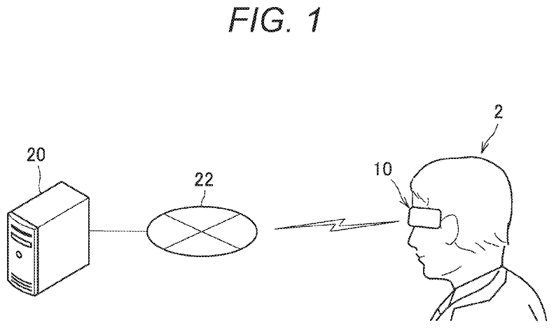

First, an exemplary configuration an information processing system according to an embodiment of the present disclosure will be described with reference to FIG. 1. As shown in FIG. 1, the information processing system according to the present embodiment includes an HMD 10, a server 20, and a communication network 22.

<1-1. HMD 10>

The HMD 10 is one example of an information processing device in the present disclosure. The HMD 10 is a head-mounted device, and can display various types of content (for example, VR content, AR content, and the like).

The HMD 10 may be a non-transmissive (shielded) HMD or a transmissive HMD. In the latter case, the HMD 10 may be, for example, an optical see-through HMD having a light control unit (for example, light control device), or may be a video see-through HMD. Note that various forms, such as a chromic element and a liquid-crystal shutter, may be employed as the light control unit. In other words, a configuration (such as a device) capable of dynamically changing transmittance can be appropriately employed as the light control unit.

The HMD 10 can include a cover portion that covers both eyes (or one eye) of a user. For example, the cover portion includes a display unit 124 as described later. Alternatively, the cover portion includes a see-through display and a light control unit 126 as described later.

{1-1-1. Display Unit 124}

Here, the display unit 124 displays a video in response to control by an output control unit 106 as described later. The display unit 124 can have a configuration as a transmissive display device. In this case, the display unit 124 projects a video by using at least some area of each of a right-eye lens and a left-eye lens (or goggle lens) included in the HMD 10 as a projection plane. Note that the left-eye lens and the right-eye lens (or goggle lens) can be formed by using, for example, a transparent material such as resin or glass.

Alternatively, the display unit 124 may have a configuration as a non-transmissive display device. For example, the display unit 124 can include a liquid crystal display (LCD), an organic light emitting diode (OLED), or the like. Note that in a case where the HMD 10 has a configuration as the video see-through HMD, a camera included in the HMD 10 (sensor unit 122 as described later) can capture a video forward of the user, and then the captured video can be sequentially displayed on the display unit 124. This allows the user to look at a forward scene through the video.

<1-2. Server 20>

The server 20 is an apparatus that manages various information items. For example, the server 20 stores various types of content such as VR content or AR content.

The server 20 can communicate with other devices via the communication network 22. For example, in a case where an acquisition request for content is received from another device (for example, HMD 10 or the like), the server 20 transmits the content indicated by the acquisition request to the another device.

Note that the server 20 can also perform various types of control on other devices (for example, HMD 10 or the like) via the communication network 22. For example, the server 20 may perform display control, voice output control, and the like on the HMD 10.

<1-3. Communication Network 22>

The communication network 22 is a wired or wireless transmission path of information transmitted from a device connected to the communication network 22. For example, the communication network 22 may include a telephone line network, the Internet, a public line network such as a satellite communication network, various local area networks (LANs) including Ethernet (registered trademark), a wide area network (WAN), and the like. Furthermore, the communication network 22 may include a dedicated line network such as an Internet protocol-virtual private network (IP-VPN).

<1-4. Summary of Issues>

The configuration of the information processing system according to the present embodiment has been described above. Meanwhile, according to a known sight line detection technique, detection accuracy in a central portion of the user's view is usually high, whereas the detection accuracy in a peripheral portion of the user's view is low. Therefore, for example, in content that displays one or more virtual objects and allows interaction (such as selection or operation) on the virtual objects on the basis of sight line detection, it is difficult for the user to select virtual objects positioned in the peripheral portion of the user's view. Note that in the present embodiment, the view can mean an image (view) that substantially fills a user's visual field according to the content displayed on the HMD 10 (such as VR content or AR content).

{1-4-1. In a Case where the User is Looking at the Central Portion of the View}

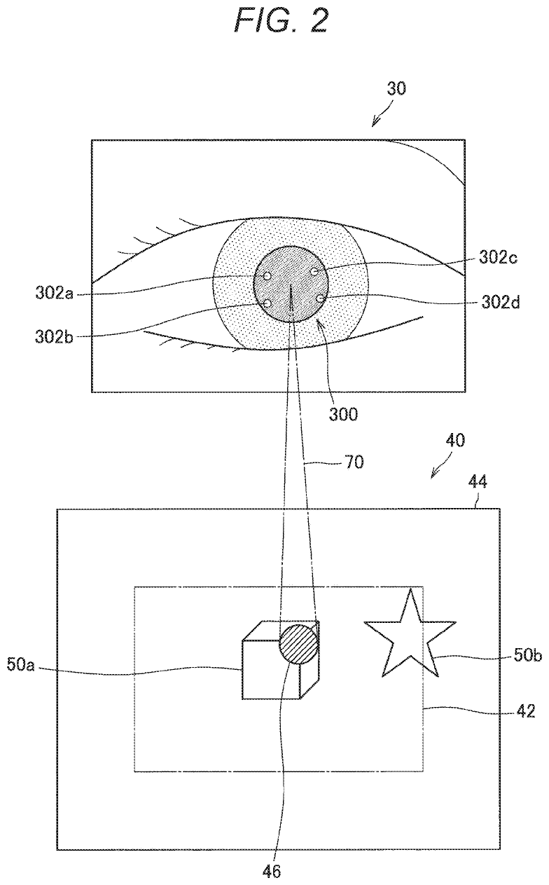

Here, details described above will be described in more detail with reference to FIGS. 2 to 7. FIG. 2 is a diagram showing an example of a captured image of an eye when the user is looking forward (captured image 30) and an example of a relationship between a view 40 of the user and a collision range 46 of a sight line. Note that in the example shown in FIG. 2, detection accuracy of a sight line is high in a central portion 42 in the view 40 of the user, whereas the detection accuracy of a sight line is low in a peripheral portion 44 in the view 40. In the example shown in FIG. 2, since the collision range 46 is positioned in the central portion 42, the detection accuracy of the sight line is high.

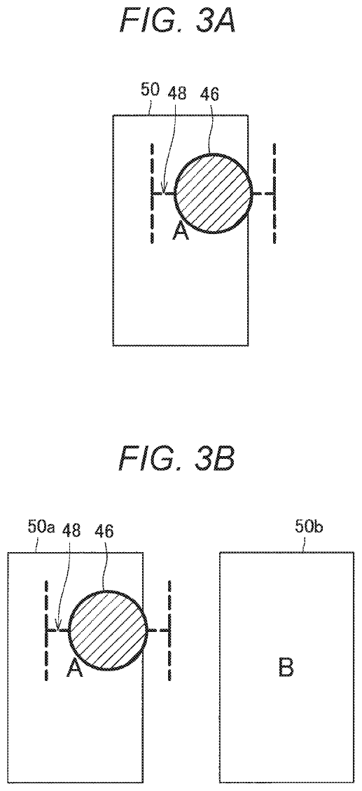

Furthermore, FIGS. 3A and 3B are diagrams each showing an example of a positional relationship between the true collision range 46 in the view of the user, a detection error range 48 of the collision range, and a virtual object 50 in a situation shown in FIG. 2. Here, the true collision range 46 indicates a true range the user is looking at in the view. The detection error range 48 of a collision range indicates a size of a range that can be detected as a collision range (due to a detection error) in a case where a position of the true collision range 46 is the same. As shown in FIGS. 3A and 3B, in the situation shown in FIG. 2 (that is, situation where the user is looking forward), since a difference between the detection error range 48 and the true collision range 46 is sufficiently small, it is unlikely that the collision range is falsely detected. For example, in the example shown in FIG. 3B, the HMD 10 can correctly identify the virtual object 50a as a virtual object intended by the user from among the two virtual objects 50.

{1-4-2. In a Case where the User is Looking at the Peripheral Portion of the View}

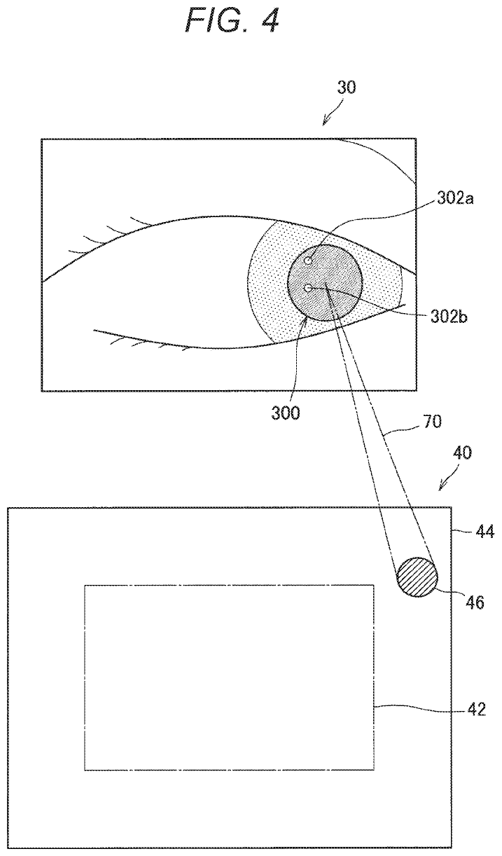

Meanwhile, FIG. 4 is a diagram showing an example of the captured image of the eye (captured image 30) when the user is looking at the peripheral portion of the view (portion corresponding to the right direction in FIG. 4) and an example of a relationship between the view 40 of the user and the collision range 46 of a sight line. In the example shown in FIG. 4, since the collision range 46 is positioned in the peripheral portion 44 of the view 40, the detection accuracy of a sight line is low.

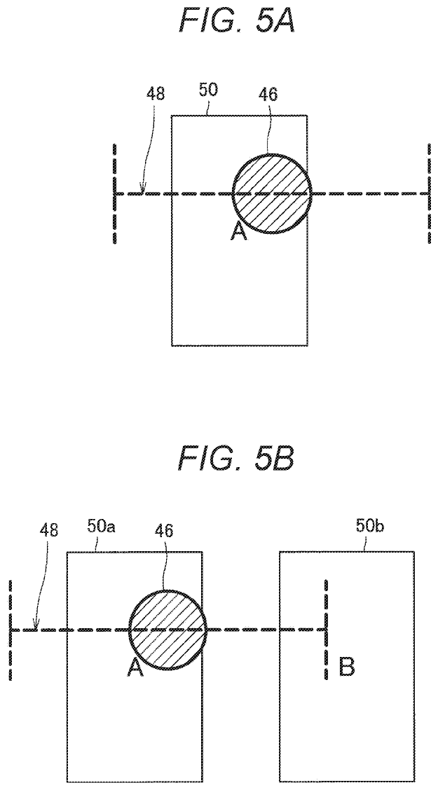

Furthermore, FIGS. 5A and 5B are diagrams each showing an example of a positional relationship between the true collision range 46 in the view of the user, the detection error range 48 of the collision range, and the virtual object 50 in a situation shown in FIG. 4. As shown in FIGS. 5A and 5B, in the situation shown in FIG. 4, since the detection accuracy of a sight line is low, the difference between the detection error range 48 and the true collision range 46 is very large.

In the example shown in FIG. 5A, a distance between one end of the detection error range 48 (right end shown in FIG. 5A) and the virtual object 50 is larger than a width of the true collision range 46. For this reason, even if the user tries to select the virtual object 50, the HMD 10 may not select the virtual object 50 by falsely detecting the sight line of the user. In the example shown in FIG. 5B, the true collision range 46 is positioned on the virtual object 50a , but one end of the detection error range 48 is positioned on another virtual object 50b (adjacent to the virtual object 50a ). For this reason, even if the user tries to select the virtual object 50a , the HMD 10 may falsely select another virtual object 50b by falsely detecting the sight line of the user. As described above, in a situation where the user is looking at the peripheral portion of the view, there is a problem that the virtual object 50a the user is looking at is not selected, or, another virtual object 50b the user is not looking at is selected.

{1-4-3. In a Case where Scan Range is Expanded}

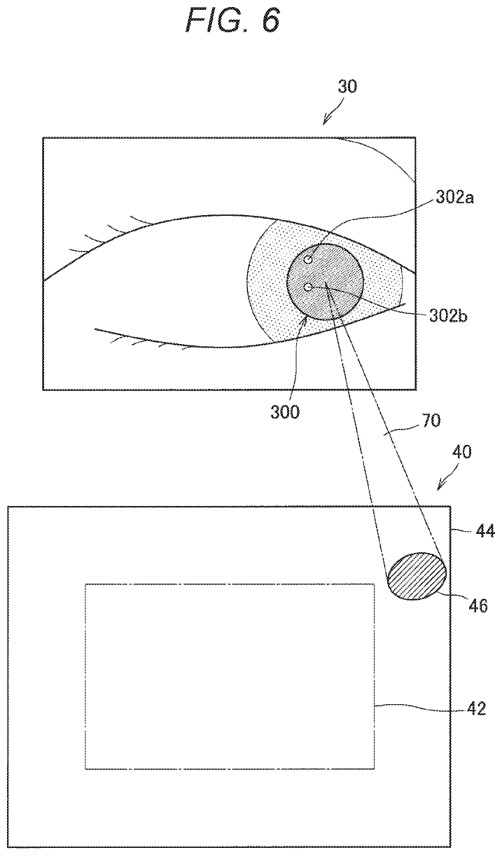

Note that as a method of solving the above problem, for example, as shown in FIG. 6, a method of expanding the scan range can be considered. However, by this method, resolution is lowered even in the central portion of the view, and thus there is a possibility that the virtual object 50 the user does not intend may be selected even in a case where the user is looking at the central portion of the view.

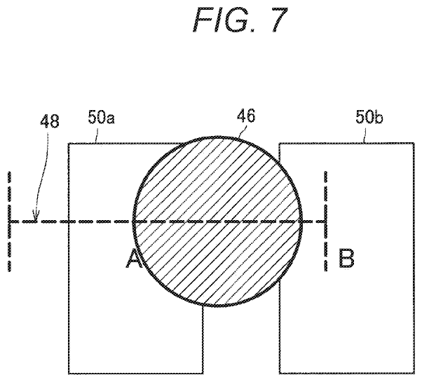

Here, details described above will be described in more detail with reference to FIGS. 6 and 7. FIG. 6 is a diagram showing the captured image 30 of the eye when the user is looking in the same direction as in the example shown in FIG. 4, and an example of a relationship between the view 40 of the user and the collision range 46 of a sight line in a case where the scan range is expanded. Furthermore, FIG. 7 is a diagram showing an example of a positional relationship between the collision range 46 in a case where the scan range is expanded, the detection error range 48 of the collision range, and the virtual object 50 in a situation shown in FIG. 6.

In the example shown in FIG. 7, the collision range 46 in a case where the scan range is expanded is positioned across two virtual objects 50. Therefore, even if the user intends to select the virtual object 50a , the HMD 10 may select none of the two virtual objects 50, or falsely select the virtual object 50b the user does not intend.

Therefore, it is preferably possible to accurately identify the virtual object intended by the user without reducing resolution in the central portion of the user's view.

Therefore, by using the above circumstance as one point to pay attention, the HMD 10 according to the present embodiment has been created. The HMD 10 according to the present embodiment can perform visibility control to estimate the position of interest of the user and then gradually reduce visibility of a second view opposite to a first view of the user corresponding to the position of interest such that the visibility of the second view of the user becomes lower than visibility of the first view. This allows the visibility of the user's view to be dynamically changed adaptively to the user's position of interest. Generally, when the user notices existence of an object of interest, the user tends to closely observe the object. Therefore, by gradually reducing the visibility of the second view, inducing head movement (involuntarily moving the head) such that the first view (that is, direction of the position of interest) is positioned in front of the user can be expected. Note that the visibility of view mentioned in the present specification may be interpreted as viewability of view.

Here, the position of interest of the user may be a position in which the user is estimated to be interested within a real space where the user is positioned, or when VR content is displayed on the HMD 10, the position of interest of the user may be a position in which the user is estimated to be interested within a virtual space corresponding to the VR content.

Furthermore, the second view may be positioned 180 degrees opposite to the first view, or may be positioned off the first view by a predetermined angle other than 180 degrees. For example, the second view may be an area 180 degrees opposite to an area corresponding to the first view in the display unit 124 with respect to the center of the display range of the display unit 124.

### 2. DETAILED DESCRIPTION OF EMBODIMENT

<2-1. Configuration>

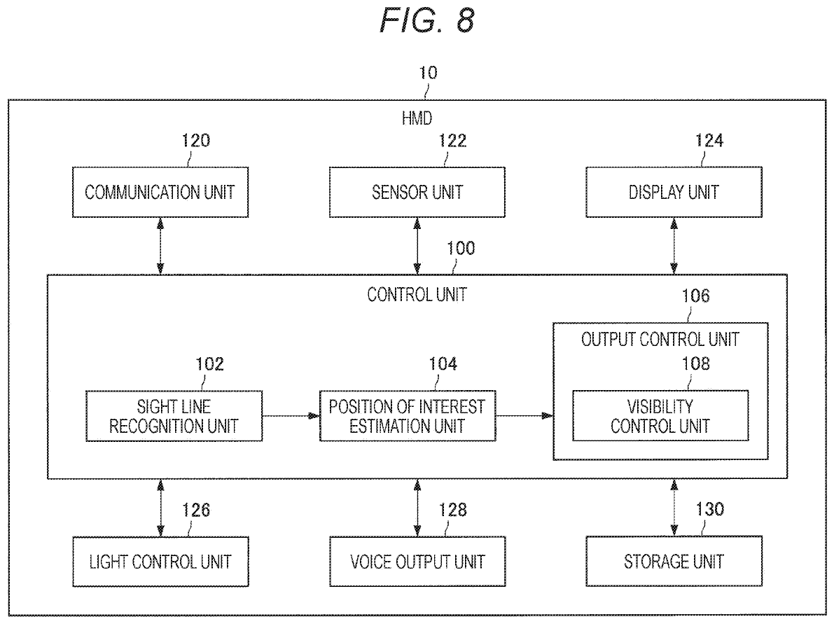

Next, the configuration according to the present embodiment will be described in detail. FIG. 8 is a functional block diagram showing an exemplary configuration of the HMD 10 according to the present embodiment. As shown in FIG. 8, the HMD 10 includes a control unit 100, a communication unit 120, the sensor unit 122, the display unit 124, the light control unit 126, a voice output unit 128, and a storage unit 130.

{2-1-1. Sensor Unit 122}

The sensor unit 122 can include, for example, a camera (image sensor), a microphone, an acceleration sensor, a gyroscope, a geomagnetic sensor, and/or a global positioning system (GPS) receiver.

For example, the sensor unit 122 senses a position, posture (such as direction and inclination), and acceleration of the HMD 10 in a real space. Furthermore, the sensor unit 122 captures an image of the eye of the user wearing the HMD 10. Furthermore, the sensor unit 122 further captures a video of an external world (for example, forward of the HMD 10) or collects sound of the external world.

{2-1-2. Control Unit 100}

The control unit 100 can include, for example, a processing circuit such as a central processing unit (CPU) 150 as described later. The control unit 100 comprehensively controls the operation of the HMD 10. Furthermore, as shown in FIG. 8, the control unit 100 includes a sight line recognition unit 102, a position of interest estimation unit 104, and the output control unit 106.

{2-1-3. Sight Line Recognition Unit 102}

The sight line recognition unit 102 detects (or recognizes) a sight line direction of the user wearing the HMD 10 on the basis of the captured image of the user's eye captured by the sensor unit 122 (camera). For example, a plurality of (for example, four) infrared light emitting diodes (LEDs) that emits light to the eye of the user wearing the HMD 10 can be installed in the HMD 10. In this case, the sight line recognition unit 102 can first identify the position of an iris in the user's eye on the basis of the captured image of the user's eye. Next, the sight line recognition unit 102 can analyze a reflection position of the light emitted from each of the plurality of LEDs by the eye (eyeball) (reflection position 302 in the example shown in FIG. 2) and a direction of the reflection by the eye on the basis of the captured image of the eye. Then, the sight line recognition unit 102 can identify the sight line direction of the user on the basis of an identification result of the position of the iris and an identification result of the reflection of the individual light by the eye.

{2-1-4. Position of Interest Estimation Unit 104}

(2-1-4-1. Estimation Example 1)

The position of interest estimation unit 104 estimates the position of interest of the user. For example, the position of interest estimation unit 104 estimates the position of interest of the user on the basis of information input by the user. As one example, the position of interest estimation unit 104 estimates the position of an object identified on the basis of the sight line direction detected by the sight line recognition unit 102 as the position of interest of the user. For example, the position of interest estimation unit 104 estimates the position of interest of the user on the basis of a stay degree of the sight line detected by the sight line recognition unit 102 and the object positioned on the sight line identified from the detected sight line direction. In more detail, the position of interest estimation unit 104 first identifies a length of time during which the detected sight line direction stays (for example, time during which a change amount in the sight line direction is within a predetermined threshold), then determines the stay degree of the sight line in accordance with the identified length of time. For example, the position of interest estimation unit 104 determines that the stay degree of the sight line increases as the identified length of time increases. Then, only in a case where the stay degree of the sight line is equal to or greater than a predetermined threshold, the position of interest estimation unit 104 estimates the position of the object positioned on the sight line as the position of interest of the user. Alternatively, the position of interest estimation unit 104 may estimate the position of the object positioned near the sight line of the user as the position of interest of the user in accordance with accuracy of sight line recognition by the sight line recognition unit 102. In other words, the position of the object identified on the basis of the sight line direction of the user detected by the sight line recognition unit 102 can be estimated as the position of interest of the user. Here, the object may be a real object or a virtual object.

For example, in a case where a video of VR content or AR content is displayed on the display unit 124, from among one or more virtual objects included in the video, the position of interest estimation unit 104 estimates the display position of the virtual object displayed in the collision range identified from the detected sight line direction (for example, virtual object that can interact) as the position of interest of the user. Alternatively, for example, in a case where the user is using AR content and the HMD 10 is a transmissive HMD, the position of interest estimation unit 104 may estimate the position of the real object positioned on the sight line direction detected (in the real space in which the user is positioned) as the position of interest of the user.

(2-1-4-2. Estimation Example 2)

Alternatively, the position of interest estimation unit 104 can also estimate the position of interest of the user on the basis of information obtained from other than the user. For example, in a case where a sound related to the user is generated, the position of interest estimation unit 104 may estimate the position corresponding to a generation source of the sound as the position of interest of the user. Note that although details will be described later, in this case, by performing “visibility control to reduce the visibility of the second view” by a visibility control unit 108, it is possible to guide the user to closely observe the direction corresponding to the generation source of the sound (that is, first view). In particular, in VR content, a sound tends to be heard less accurately than in a real space, and the user is less likely to notice the generated sound, and therefore an effect of the guidance by the visibility control unit 108 can be larger.

Here, the sound related to the user may be a predetermined voice output in VR content or AR content the user is using (for example, a voice registered in advance to draw user's attention (for example, an utterance of a virtual object (such as a character)), a warning sound, and the like). In this case, the position of interest estimation unit 104 may estimate, for example, the display position of the virtual object that is associated with the voice and displayed on the display unit 124 as the position of interest of the user. Alternatively, the position of interest estimation unit 104 may estimate the position of the virtual object associated with the voice in the virtual space corresponding to the VR content as the position of interest of the user.

Alternatively, the sound related to the user may be a sound related to the user that is emitted within the real space where the user is positioned. For example, the sound related to the user may be another person's utterance to the user, an alert, an advertisement, music, or the like in a facility where the user is positioned or outdoors, or a cry of an animal positioned near the user. Alternatively, the sound related to the user may be a sound emitted from a device owned by the user (for example, a telephone such as a smartphone, a tablet terminal, or a clock). In these cases, the position of interest estimation unit 104 may, for example, identify a direction in which the sound comes on the basis of a sound collection result by (a microphone included in) the sensor unit 122, and then estimate, as the position of interest of the user, the position of the real object that has emitted the sound (within the real space), the position being identified on the basis of the direction in which the sound comes.

(2-1-4-3. Estimation Example 3)

Alternatively, in the real space where the user is positioned, the position of interest estimation unit 104 can also estimate the position of a real object in which the user is estimated to be interested as the position of interest of the user. Alternatively, when the user is using VR content, in the virtual space corresponding to the VR content, the position of interest estimation unit 104 may estimate the position of a virtual object in which the user is estimated to be interested as the position of interest of the user.

For example, user's preference information and user's action history (for example, browsing history of web sites, posting history in social networking services (SNS), purchasing history of goods, or the like) can be stored in the storage unit 130. In this case, for example, in a case where a video of VR content is displayed on the display unit 124, first, the position of interest estimation unit 104 can determine one after another whether or not a virtual object exists with the degree of interest of the user equal to or greater than a predetermined threshold among one or more virtual objects included in the video, on the basis of the user preference information and action history. Then, in a case where it is determined that at least one virtual object exists with the degree of interest of the user equal to or greater than the predetermined threshold, the position of interest estimation unit 104 can estimate the display position of any of the virtual objects (for example, virtual object with the highest degree of interest) (or, position of the virtual object in the virtual space corresponding to the VR content) as the position of interest of the user.

Alternatively, for example, in a case where the user is using AR content and the HMD 10 is a transmissive HMD, the position of interest estimation unit 104 may determine one after another whether or not a real object exists with the degree of interest of the user equal to or greater than the predetermined threshold among one or more real objects positioned around the user on the basis of the user preference information and action history. Then, in a case where a real object exists with the degree of interest of the user equal to or greater than the predetermined threshold, the position of interest estimation unit 104 may estimate the position of any of the corresponding real objects (for example, a real object with the highest degree of interest) in the real space as the position of interest of the user.

{2-1-5. Output Control Unit 106}

The output control unit 106 controls output of various signals. For example, when VR content or AR content is activated, the output control unit 106 causes the display unit 124 to display a video of the VR content or the AR content, and causes the voice output unit 128 to output a voice of the VR content or the AR content.

Furthermore, the output control unit 106 includes the visibility control unit 108.

{2-1-6. Visibility Control Unit 108}

(2-1-6-1. Example of Control to Reduce Visibility)

The visibility control unit 108 performs visibility control to change the visibility of the user's view on the basis of an estimation result by the position of interest estimation unit 104. For example, the visibility control unit 108 performs the visibility control to gradually reduce the visibility of the second view such that the visibility of the second view of the user different from the first view of the user corresponding to the position of interest estimated by the position of interest estimation unit 104 becomes lower than the visibility of the first view. As one example, in the visibility control, the visibility control unit 108 gradually reduces the visibility from a position farthest from the first view in the second view toward a position closest to the first view (in the second view). For example, first, the visibility control unit 108 makes the visibility of the position farthest from the first view in the second view lower than the visibility of the first view. Then, the visibility control unit 108 gradually expands an area where the visibility is lower than the visibility of the first view from the position farthest from the first view in the second view toward the position closest to the first view (in the second view).

Note that the visibility control unit 108 can start the “visibility control to reduce the visibility of the second view” on the basis of a determination result of head movement of the user according a result of the sensing by the sensor unit 122. For example, when it is determined that the user's head is stationary, the visibility control unit 108 starts the visibility control to reduce the visibility of the second view. Furthermore, while it is determined that the user's head is moving, the visibility control unit 108 does not start the visibility control to reduce the visibility of the second view.

Specific details of the “visibility control to reduce the visibility of the second view” will be described below. For example, in a case where the HMD 10 is an optical see-through HMD, the visibility control to reduce the visibility of the second view can include performing control on the light control unit 126 as described later so as to gradually reduce transmittance of the area corresponding to the second view in the see-through display of the HMD 10. As one example, the visibility control unit 108 may gradually reduce the transmittance of the area corresponding to the second view in the see-through display by sequentially driving (out of the plurality of light control devices included in the light control unit 126) individual light control devices from the light control device installed farthest from the first view in the second view to the light control device installed closest to the first view (in the second view). Alternatively, the visibility control unit 108 may gradually reduce the transmittance of the area corresponding to the second view in the see-through display by gradually moving a predetermined slit installed in the HMD 10 from the position farthest from the first view in the second view toward the position closest to the first view (in the second view).

Alternatively, for example, in a case where the HMD 10 is an HMD of a type other than the optical see-through type, the visibility control to reduce the visibility of the second view can include gradually changing a display mode in the display range corresponding to the second view in the display unit 124 from the position farthest from the first view in the second view toward the position closest to the first view (in the second view). For example, the visibility control unit 108 may gradually change display color in the display range corresponding to the second view to a predetermined color (for example, black) from the position farthest from the first view in the second view toward the position closest to the first view (in the second view), or may gradually reduce luminance, lightness, and/or saturation in the display range, or may gradually reduce resolution in the display range. Note that the predetermined color is not particularly limited if the predetermined color can produce an effect of obstructing a user's visual field. For example, in a case where VR content is displayed in only part of the display range of the display unit 124, the predetermined color may be the same as a color of an area displayed adjacent to the VR content (for example, background).

### SPECIFIC EXAMPLE

Details of control by the visibility control unit 108 will be described in more detail below. For example, the visibility control unit 108 performs the visibility control to reduce the visibility of the second view on the basis of a difference between the user's sight line direction detected by the sight line recognition unit 102 and the user's forward direction (that is, sight line direction when the user looks forward) and the estimation result by the position of interest estimation unit 104. Note that the sight line direction when the user looks forward may be estimated to be, for example, the same as the head direction of the user sensed by the sensor unit 122.

For example, in a case where the difference between the detected sight line direction of the user and the sight line direction when the user looks forward is equal to or less than the predetermined threshold, the visibility control unit 108 inhibits performance of the visibility control to reduce the visibility of the second view. Note that in the present embodiment, “inhibit” can also mean partial or incremental restriction of the degree of visibility control or prohibition of the visibility control itself. In the following, descriptions will be made focusing on a case where the visibility control is prohibited, in other words, a case where the visibility control to reduce the visibility of the second view is not performed.

Furthermore, in a case where the difference between the detected sight line direction of the user and the sight line direction when the user looks forward is larger than the predetermined threshold, the visibility control unit 108 performs the visibility control to reduce the visibility of the second view on the basis of the estimation result by the position of interest estimation unit 104. In this case, the visibility control unit 108 can perform the visibility control to reduce the visibility of the second view on the basis of whether or not a plurality of virtual objects is positioned in the first view (identified from the estimation result by the position of interest estimation unit 104). For example, in a case where a plurality of virtual objects is positioned in the first view, the visibility control unit 108 performs the visibility control to reduce the visibility of the second view. Furthermore, in a case where a plurality of virtual objects is not positioned in the first view (that is, in a case where only one virtual object exists in the first view or no virtual object exists at all), the visibility control unit 108 inhibits the performance of the visibility control to reduce the visibility of the second view.

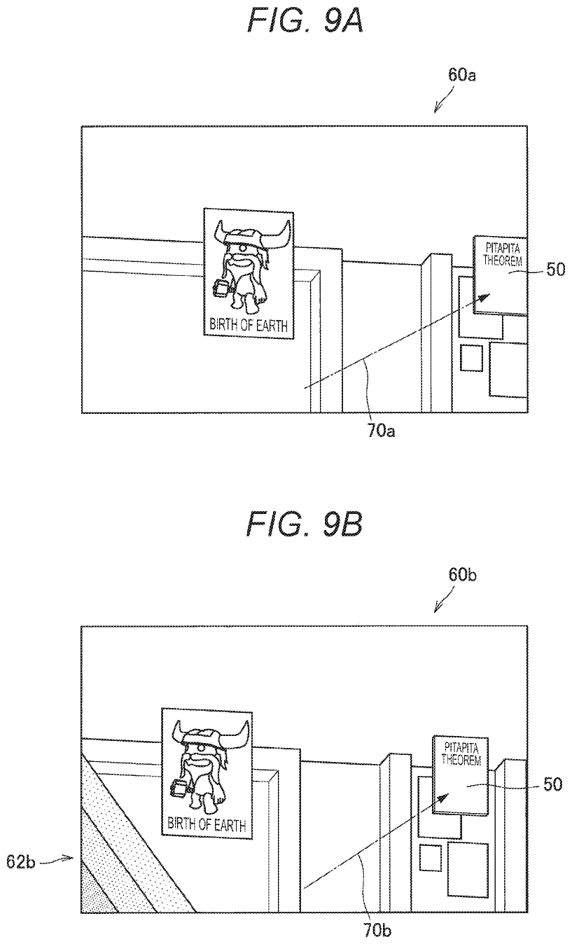

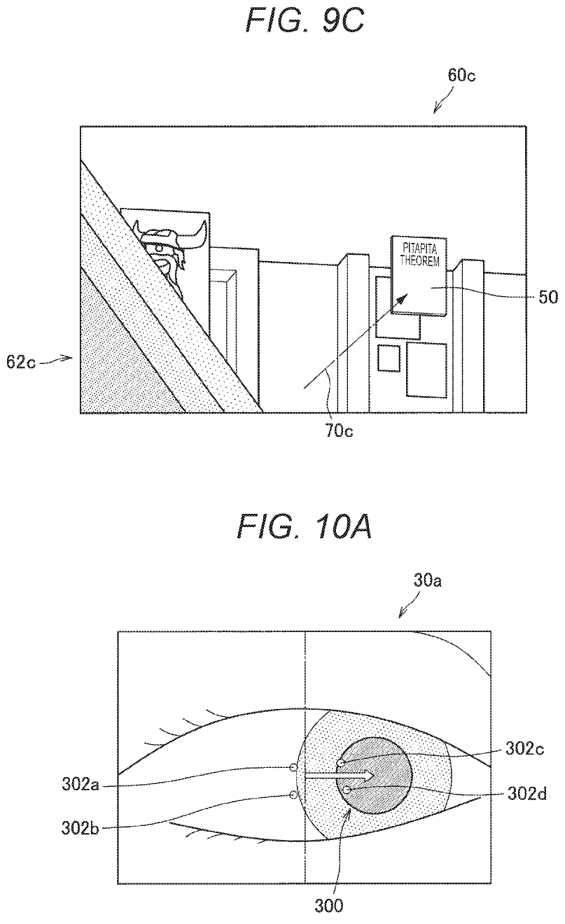

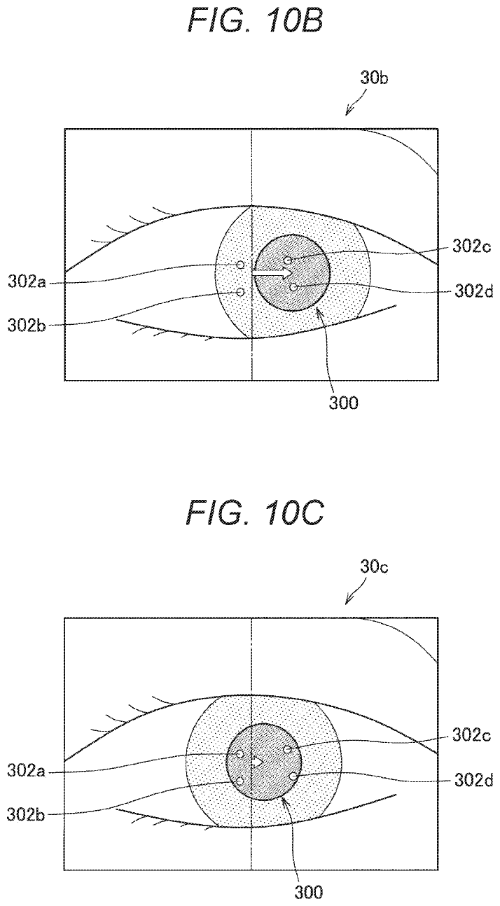

Here, with reference to FIGS. 9A to 10C, the above functions will be described in more detail. FIGS. 9A to 9C are views each showing a modified example of the display mode of the display range corresponding to the second view by the visibility control unit 108 while a video 60 of VR content is displayed on the display unit 124. Note that FIGS. 9A to 9C each show an example in which the video 60 shown in each view is displayed in order of FIGS. 9A, 9B, and 9C as time elapses. Furthermore, FIGS. 10A to 10C are views showing examples of the captured image 30 of the eye captured when (or immediately before or after) the video 60 shown in FIGS. 9A to 9C is displayed, respectively. Note that (vertical) alternate long and short dash lines shown in FIGS. 10A to 10C indicate the position of the substantial center of the user's eye.

When the video 60a shown in FIG. 9A is displayed, it is assumed that the head of the user is stationary substantially. For example, it is assumed that an amount of movement of the user's head per unit time, which is sensed by (a gyroscope or the like included in) the sensor unit 122, is within a predetermined threshold. Furthermore, when the video 60a shown in FIG. 9A is displayed, it is assumed that the user points a sight line 70 at the virtual object 50 shown in FIG. 9A (that is, virtual object 50 positioned in the peripheral portion of the user's view).

In this case, it is determined that the difference between the sight line direction of the user detected on the basis of the captured image 30a of the eye shown in FIG. 10A and the sight line direction when the user looks forward is larger than a predetermined threshold. Therefore, the visibility control unit 108 starts the visibility control to gradually reduce the visibility of the second view (specifically, an area opposite to the virtual object 50, that is, an area on the lower left side in the video 60a in FIG. 9A). This can induce head movement so as to move the head such that the virtual object 50 is positioned on a more forward side of the user.

FIG. 9B is a view showing a display example of a video 60b after a predetermined time has elapsed since when the video 60a shown in FIG. 9A is displayed. Furthermore, FIG. 10B is a view showing an example of the captured image 30 of the eye captured when (or immediately before or after) the video 60b shown in FIG. 9B is displayed. As in a visual presentation area 62 shown in FIG. 9B, the visibility control unit 108 gradually changes the display color to a predetermined color (for example, black) from a position farthest from the virtual object 50 toward a vicinity of the virtual object 50 in the area opposite to the virtual object 50 (second view). Since this will start changing the display color earlier as the position from the virtual object 50 is farther, as shown in FIG. 9B, as the position from the virtual object 50 is farther, (instead of the original display color in the corresponding VR content), the display color can be closer to the predetermined color.

FIG. 9C is a view showing a display example of a video 60c after a predetermined time has elapsed since when the video 60b shown in FIG. 9B is displayed. Furthermore, FIG. 10C is a view showing an example of the captured image 30 of the eye captured when (or immediately before or after) the video 60c shown in FIG. 9C is displayed. As shown in FIG. 9C, a size of a visual presentation area 62c is larger than a size of a visual presentation area 62b shown in FIG. 9B, and the display color in the visual presentation area 62c is changed to a color closer to the predetermined color than in the visual presentation area 62b . Thus, since the display color is gradually changed to the predetermined color from the opposite side of the virtual object 50 with respect to the center of the display unit 124, as shown in FIGS. 10A to 10C, the user can move the head unconsciously (head movement can be induced) such that the virtual object 50 is positioned in front of the user. As a result, the collision range of the sight line in the user's view moves to the central portion of the view, and thus the detection accuracy of the collision range is improved. Therefore, the HMD 10 can accurately identify the virtual object 50 as an object to be selected (or operated) by the user.

Note that FIGS. 9B and 9C show examples in which the visual presentation area 62 is a triangle, but the visual presentation area 62 is not limited to this example. For example, out of the visual presentation area 62, a shape on the virtual object 50 side (that is, the first view side) may be curved. As one example, out of the visual presentation area 62, a contour line closest to the first view may not be a straight line but may be a curved line (for example, curved line with a protruded shape with respect to the second view side).

(2-1-6-2. Modification 1)

A functional modification of the visibility control unit 108 will be described below. For example, after starting the visibility control to gradually reduce the visibility of the second view, the visibility control unit 108 may stop the visibility control on the basis of the determination result of the head movement of the user. For example, in a case where a length of time during which it is determined that the user's head is not moving becomes equal to or greater than a predetermined time after the start of the visibility control, the visibility control unit 108 may stop the visibility control. Alternatively, in a case where it is detected that the user's head has moved in a direction opposite to a direction of reducing the visibility of the second view (that is, direction from the first view toward the second view) after the start of the visibility control, the visibility control unit 108 may stop the visibility control.

(2-1-6-3. Modification 2)

As another modification, the visibility control unit 108 may change a speed in reducing the visibility of the second view on the basis of a determination result of a speed of the head movement of the user. For example, as the speed of the head movement of the user increases, the visibility control unit 108 may increase the speed in reducing the visibility of the second view.

Generally, when the user moves the head while watching VR content, the user may feel VR sickness. According to this modification, as the speed of the head movement of the user increases, out of the second view, the speed with which the area with low visibility expands increases, and thus it is expected that VR sickness is avoided. Furthermore, in general, the faster the user moves the head, the less likely the user notices changes in the video. For example, even if the speed in reducing the visibility of the second view is increased (as in this modification), the user is unlikely to notice that the visibility of the second view has been reduced (for example, that the display mode has been changed). Therefore, the head movement can be induced as in the example described in Section 2-1-6-1.

Alternatively, the visibility control unit 108 may change the speed in reducing the visibility or the degree of reduction in the visibility depending on the position in the second view. For example, the visibility control unit 108 may make the speed in reducing the visibility slower as the distance from the position to the estimated position of interest of the user decreases in the second view. Alternatively, the visibility control unit 108 may reduce the degree of reduction in the visibility as the distance from the position to the estimated position of interest of the user decreases in the second view.

{2-1-7. Communication Unit 120}

The communication unit 120 can include, for example, a communication device 166 as described later. The communication unit 120 transmits and receives information to and from other devices. For example, the communication unit 120 transmits, to the server 20, an acquisition request for content (for example, VR content, AR content, and the like) in response to control by the control unit 100. Furthermore, the communication unit 120 receives various information items (such as content) from the server 20.

{2-1-8. Light Control Unit 126}

The light control unit 126 changes, for example, transmittance (or lightness) of each of one or more see-through displays of the HMD 10 in response to control by the visibility control unit 108. The light control unit 126 is installed outside each of the one or more see-through displays, and can include a plurality of light control devices. For example, the degree of coloring of each of the plurality of light control devices can change in accordance with a supply condition of an electric current. With this configuration, the transmittance (or lightness) is changed in each part corresponding to an installation position of each individual light control device in the see-through display.

Note that the HMD 10 may include the light control unit 126 only in a case where the HMD 10 is an optical see-through HMD.

{2-1-9. Voice Output Unit 128}

The voice output unit 128 outputs a sound in response to the control by the output control unit 106. The voice output unit 128 can include, for example, a speaker, an earphone, or a headphone.

{2-1-10. Storage Unit 130}

The storage unit 130 can include, for example, a storage device 164 as described later. The storage unit 130 stores various data (for example, content and the like) and various types of software.

Note that the configuration according to the present embodiment is not limited to the example described above. For example, the HMD 10 may not include the light control unit 126 and/or the voice output unit 128.

<2-2. Processing Flow>

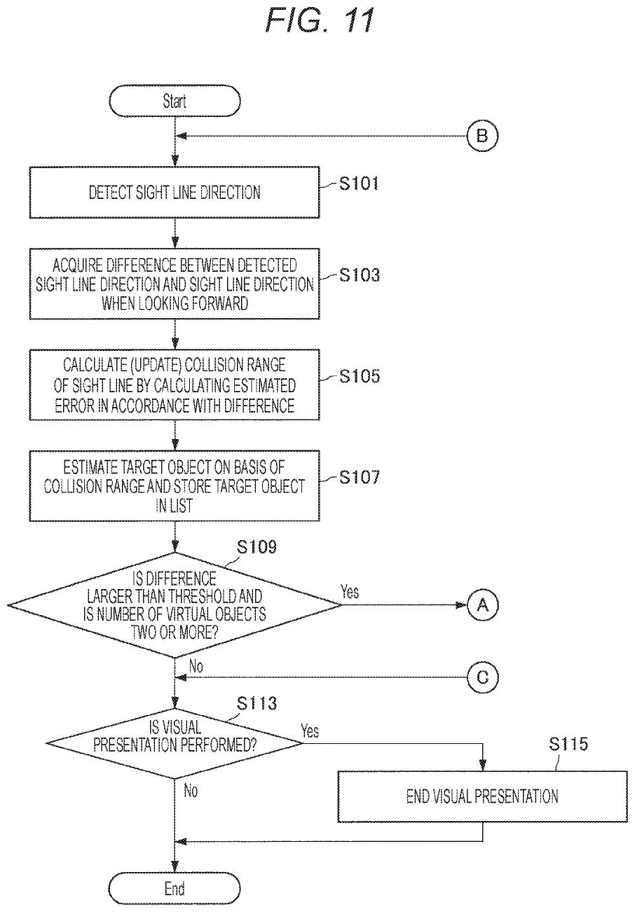

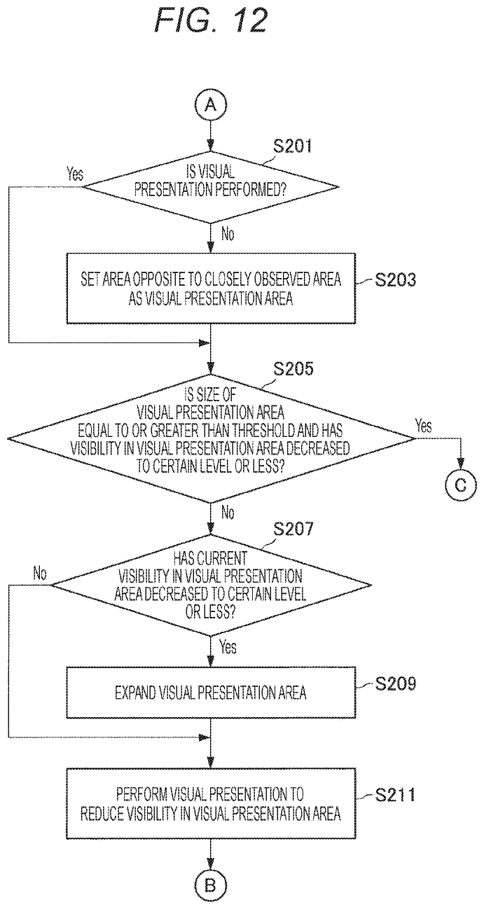

The configuration according to the present embodiment has been described above. Next, one example of a processing flow according to the present embodiment will be described with reference to FIGS. 11 and 12.

FIG. 11 is a flowchart showing part of the processing flow according to the present embodiment. As shown in FIG. 11, first, the sensor unit 122 of the HMD 10 acquires the captured image of the eye by capturing the eye of the user. Then, the sight line recognition unit 102 detects the sight line direction of the user wearing the HMD 10 on the basis of the acquired captured image (S101).

Subsequently, the position of interest estimation unit 104 acquires a sensing result of the head direction of the user by the sensor unit 122, and identifies the sight line direction when the user looks forward on the basis of the sensing result. Then, the position of interest estimation unit 104 calculates (an absolute value of) the difference between the sight line direction detected in S101 and the sight line direction when the user looks forward (S103).

Subsequently, the position of interest estimation unit 104 estimates a detection error of the sight line in S101 in accordance with the difference calculated in S103. Then, the position of interest estimation unit 104 calculates (or updates) the collision range of the sight line on the basis of the sight line direction detected in 5101 and the estimated error (S105).

Subsequently, the position of interest estimation unit 104 identifies existence of a virtual object corresponding to the collision range on the basis of one or more virtual objects displayed on the display unit 124 (such as a virtual object that can interact) and the calculated collision range of the sight line. Then, in a case where one or more virtual objects corresponding to the collision range exist, the position of interest estimation unit 104 identifies each of the virtual objects, and stores identification information about the identified individual virtual object in a list (in the storage unit 130) (S107).

Subsequently, the visibility control unit 108 determines whether or not the absolute value of the difference calculated in S103 is larger than a predetermined threshold and the number of virtual objects corresponding to the collision range identified in S107 is two or more (S109). In a case where it is determined that the condition of S109 is not satisfied (S109: No), next, the visibility control unit 108 determines whether or not visual presentation (display control) for reducing the visibility of the second view is performed (S113). In a case where the visual presentation is not performed (S113: No), the processing flow ends.

On the other hand, in a case where the visual presentation is performed (S113: Yes), the visibility control unit 108 ends the visual presentation (S115). Then, the processing flow ends.

Here, the processing flow in a case where it is determined that the condition of 5109 is satisfied (S109: Yes) will be described with reference to FIG. 12.

As shown in FIG. 12, in a case where the visual presentation is currently performed (S201: Yes), the visibility control unit 108 performs the processing of S205 and subsequent processing as described later.

On the other hand, in a case where the visual presentation is not currently performed (S201: No), the visibility control unit 108 sets the area opposite to the collision range calculated in S105 as the visual presentation area (area corresponding to the second view) (S203).

Subsequently, the visibility control unit 108 determines whether or not the size of the current visual presentation area is equal to or greater than a threshold and the degree of visibility in the visual presentation area has decreased to a certain level or less (S205). In a case where it is determined that the condition of S205 is satisfied (S205: Yes), the visibility control unit 108 performs the processing of S113 and subsequent processing.

On the other hand, in a case where the size of the visual presentation area is less than the threshold and the degree of visibility in the visual presentation area has decreased to a certain level or less (S207: Yes), first, the visibility control unit 108 expands the visual presentation area toward the first view (that is, the area corresponding to the collision range calculated in S105) by a certain ratio (S209). Then, the visibility control unit 108 performs the processing of S211 as described later.

On the other hand, in a case where the size of the visual presentation area is less than the threshold and the degree of visibility in the visual presentation area has decreased by less than a certain level (S207: No), the visibility control unit 108 performs visual presentation so as to gradually reduce the visibility within the visual presentation area. For example, the visibility control unit 108 gradually increases an amount of change in the display mode in the visual presentation area (in other words, amount of visual presentation) (S211). Thereafter, the HMD 10 repeats the processing of S101 and subsequent processing again.

<2-3. Advantageous Effects>

As described above, the HMD 10 according to the present embodiment performs visibility control to estimate the position of interest of the user and then gradually reduce the visibility of the second view such that the visibility of the second view of the user opposite to the first view of the user corresponding to the position of interest becomes lower than the visibility of the first view. This allows the visibility of the user's view to be dynamically reduced adaptively to the user's position of interest. Furthermore, since the visibility of the second view is gradually reduced, the user is unlikely to notice that the visibility of the second view has changed. Therefore, for example, inducing head movement (involuntarily moving the head) such that the first view (that is, direction of the position of interest) is positioned in front of the user can be expected.

As a result, it is possible to improve the accuracy of sight line detection, for example, without narrowing the scan range (that is, without reducing the resolution in the central portion of the user's view). This enables the HMD 10 to accurately identify the virtual object the user intends among a plurality of virtual objects displayed. For example, even if the plurality of virtual objects is displayed closely, the user's desired virtual object will be positioned in front of the user and detection accuracy of the sight line is improved, and therefore the HMD 10 can accurately identify the desired virtual object. Then, the user can perform an intended operation (such as selection) on the desired virtual object. Therefore, user experience can be naturally improved. Note that although the above embodiment has mentioned the detection accuracy of the sight line, it should be noted that dynamic control of the visibility of the present embodiment can be applied to a system configuration that does not use the sight line detection.

### 3. HARDWARE CONFIGURATION

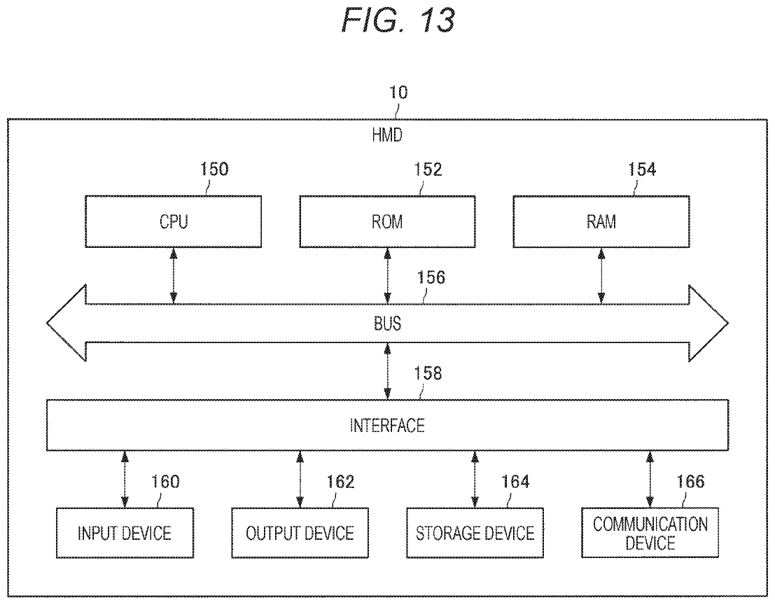

Next, the hardware configuration of the HMD 10 according to the present embodiment will be described with reference to FIG. 13. As shown in FIG. 13, the HMD 10 includes a CPU 150, a read only memory (ROM) 152, a rondom access memory (RAM) 154, a bus 156, an interface 158, an input device 160, an output device 162, a storage device 164, and a communication device 166.

The CPU 150 functions as an arithmetic processing device and a control device, and controls the overall operation in the HMD 10 in accordance with various programs. Furthermore, the CPU 150 implements the function of the control unit 100 in the HMD 10. Note that the CPU 150 includes a processor such as a microprocessor.

The ROM 152 stores programs to be used by the CPU 150, control data such as calculation parameters, and the like.

The RAM 154 temporarily stores, for example, programs to be executed by the CPU 150, data in use, and the like.

The bus 156 includes a CPU bus and the like. The bus 156 connects the CPU 150, the ROM 152, and the RAM 154 to one another.

The interface 158 connects the input device 160, the output device 162, the storage device 164, and the communication device 166 to the bus 156.

The input device 160 includes, for example, an input unit for inputting information by the user such as a touch panel, a button, a switch, a lever, and a microphone, and an input control circuit that generates an input signal on the basis of an input by the user and outputs the input signal to the CPU 150.

The output device 162 includes a projector and a display device such as, for example, a display such as an LCD or an OLED. Furthermore, the output device 162 includes a voice output device such as a speaker.

The storage device 164 is a device for data storage that functions as the storage unit 130. The storage device 164 includes, for example, a storage medium, a recording device that records data in the storage medium, a reading device that reads data from the storage medium, or a deletion device that deletes data recorded in the storage medium.

The communication device 166 is a communication interface including, for example, a communication device (for example, a network card or the like) for connecting to the communication network 22 or the like. Furthermore, the communication device 166 may be a communication device compatible with wireless LAN, a communication device compatible with long term evolution (LTE), or a wire communication device that performs wired communication. The communication device 166 functions as the communication unit 120.

### 4. MODIFICATIONS

The preferred embodiment of the present disclosure has been described in detail above with reference to the accompanying drawings, but the present disclosure is not limited to such an example. It is obvious that persons of ordinary skill in the technical field to which the present disclosure belongs can conceive various modifications or alterations within the scope of the technical idea described in the claims, and it is of course understood that these also fall within the technical scope of the present disclosure.

<4-1. Modification 1>

For example, the sight line recognition unit 102, the position of interest estimation unit 104, and the visibility control unit 108 may be included in the server 20 instead of being included in the HMD 10. In this case, the information processing device in the present disclosure may be the server 20. For example, the server 20 may receive a sensing result by (the sensor unit 122 of) the HMD 10 (for example, the captured image of the user's eye or the like) from the HMD 10, estimate the position of interest of the user on the basis of the sensing result, and perform the “visibility control to gradually reduce the visibility of the second view” described above on the HMD 10.

Moreover, in this modification, the display unit 124 may be a stationary display (instead of being included in the HMD 10). For example, the stationary display includes an LCD, an OLED, or the like. Furthermore, the display unit 124 may be installed on a wall or ceiling in a dedicated dome-shaped facility. In this case, the server 20 may receive a sensing result (for example, captured image of the user's eye) by various sensors (such as a camera) installed in an environment where the user is positioned and various sensors carried by the user (such as an acceleration sensor) from these sensors, estimate the position of interest of the user on the basis of the sensing result, and then perform the “visibility control to gradually reduce the visibility of the second view” on the display unit 124.

Alternatively, the display unit 124 may be a 3D projector, and a video may be projected by the 3D projector onto a projection target (for example, a wall or screen in a room (such as a dedicated dome-shaped facility)).

<4-2. Modification 2>

Alternatively, the information processing device may be a general-purpose personal computer (PC), a tablet terminal, a game machine, a mobile phone such as a smartphone, a portable music player, another wearable device such as, for example, a smart watch, or a robot. Also in this case, as in modification 1, the information processing device can perform the “visibility control to gradually reduce the visibility of the second view” on the HMD 10.

<4-3. Modification 3>

Each step in the processing flow according to the embodiment described above may not necessarily be processed in the order described. For example, each step may be processed in appropriately changed order. Each step may be processed partially in parallel or individually instead of being processed time-sequentially. Some of the described steps may be omitted or other steps may be added.

According to the embodiment described above, it is also possible to provide a computer program for causing hardware such as the CPU 150, the ROM 152, and the RAM 154 to exhibit functions equivalent to each component of the HMD 10 according to the embodiment described above. Furthermore, a storage medium having the computer program recorded thereon is also provided.

Furthermore, the effects described in the present specification are merely descriptive or illustrative and not restrictive. That is, the technique according to the present disclosure can exhibit other effects obvious to those skilled in the art from the description in the present specification, in addition to or instead of the effects described above.

Note that the following configurations also belong to the technical scope of the present disclosure.

(1)

An information processing device including:

a position of interest estimation unit configured to estimate a position of interest of a user; and

a visibility control unit configured to perform visibility control to gradually reduce visibility of a second view opposite to a first view of the user corresponding to the position of interest such that the visibility of the second view of the user becomes lower than visibility of the first view.

(2)

The information processing device according to the (1), in which in the visibility control, the visibility control unit gradually reduces the visibility from a position farthest from the first view in the second view toward a position closest to the first view in the second view.

(3)

The information processing device according to the (2), in which in the visibility control, the visibility control unit gradually expands an area where the visibility is lower than the visibility of the first view from the position farthest from the first view in the second view toward the position closest to the first view in the second view.

(4)

The information processing device according to the (2) or (3), in which the visibility control unit performs the visibility control on the basis of a sensing result of movement of a head of the user.

(5)

The information processing device according to the (4), in which

when it is determined that the head of the user is stationary, the visibility control unit starts the visibility control, and

while it is determined that the head of the user is moving, the visibility control unit does not start the visibility control.

(6)

The information processing device according to the (4), in which in the visibility control, as a speed of the sensed movement of the head of the user increases, the visibility control unit increases a speed in reducing the visibility of the second view.

(7)

The information processing device according to any one of the (4) to (6), in which the visibility control unit performs the visibility control on a cover portion covering the view of the user.

(8)

The information processing device according to the (7), in which

the cover portion includes a see-through display and a light control unit, and

in the visibility control, the visibility control unit controls the light control unit such that transmittance of an area corresponding to the second view in the see-through display gradually decreases.

(9)

The information processing device according to the (7), in which

the cover portion includes a display unit, and

in the visibility control, the visibility control unit gradually changes a display color such that the display color in a display range corresponding to the second view in the display unit becomes a predetermined color.

(10)

The information processing device according to the (7), in which

the cover portion includes a display unit, and

in the visibility control, the visibility control unit gradually reduces luminance or resolution in a display range corresponding to the second view in the display unit.

(11)

The information processing device according to any one of the (7) to (10), in which

the information processing device is a head-mounted device, and

the information processing device further includes the cover portion.

(12)

The information processing device according to any one of the (2) to (11), in which the position of interest estimation unit estimates a position of an object identified on the basis of a sight line direction of the user detected by a sight line recognition unit as the position of interest of the user.

(13)

The information processing device according to any one of the (2) to (11), in which in a case where a sound related to the user is generated, the position of interest estimation unit estimates a position corresponding to a generation source of the sound as the position of interest of the user.

(14)

The information processing device according to any one of the (2) to (11), in which the position of interest estimation unit estimates, as the position of interest of the user, a position of an object in which the user is estimated to be interested in a real space in which the user is positioned or in a virtual space corresponding to virtual reality content the user is using.

(15)

The information processing device according to the (12), in which the visibility control unit performs the visibility control on the basis of a difference between the sight line direction of the user and a front direction of the user.

(16)

The information processing device according to the (15), in which

in a case where the difference between the sight line direction of the user and the front direction of the user is greater than a predetermined threshold, the visibility control unit performs the visibility control, and

in a case where the difference between the sight line direction of the user and the front direction of the user is equal to or less than the predetermined threshold, the visibility control unit inhibits performance of the visibility control.

(17)

The information processing device according to the (16), in which

the first view is a view corresponding to the sight line direction of the user, and

the visibility control unit further performs the visibility control on the basis of whether or not a plurality of virtual objects is positioned in the first view.

(18)

The information processing device according to the (17), in which

in a case where the plurality of virtual objects is positioned in the first view, the visibility control unit performs the visibility control, and

in a case where the plurality of virtual objects is not positioned in the first view, the visibility control unit inhibits performance of the visibility control.

(19)

An information processing method including:

estimating a position of interest of a user; and

performing, by a processor, visibility control to gradually reduce visibility of a second view opposite to a first view of the user corresponding to the position of interest such that visibility of the second view of the user becomes lower than visibility of the first view.

(20)

A program for causing a computer to function as:

a position of interest estimation unit configured to estimate a position of interest of a user; and

a visibility control unit configured to perform visibility control to gradually reduce visibility of a second view opposite to a first view of the user corresponding to the position of interest such that the visibility of the second view of the user becomes lower than visibility of the first view.

### REFERENCE SIGNS LIST

10 HMD
20 Server
22 Communication network
100 Control unit
102 Sight line recognition unit
104 Position of interest estimation unit
106 Output control unit
108 Visibility control unit
120 Communication unit
122 Sensor unit
124 Display unit
126 Light control unit
128 Voice output unit
130 Storage unit

1. An information processing device comprising:
a position of interest estimation unit configured to estimate a position of interest of a user; and
a visibility control unit configured to perform visibility control to gradually reduce visibility of a second view opposite to a first view of the user corresponding to the position of interest such that the visibility of the second view of the user becomes lower than visibility of the first view.

2. The information processing device according to claim 1, wherein in the visibility control, the visibility control unit gradually reduces the visibility from a position farthest from the first view in the second view toward a position closest to the first view in the second view.

3. The information processing device according to claim 2, wherein in the visibility control, the visibility control unit gradually expands an area where the visibility is lower than the visibility of the first view from the position farthest from the first view in the second view toward the position closest to the first view in the second view.

4. The information processing device according to claim 2, wherein the visibility control unit performs the visibility control on a basis of a sensing result of movement of a head of the user.

5. The information processing device according to claim 4, wherein
when it is determined that the head of the user is stationary, the visibility control unit starts the visibility control, and
while it is determined that the head of the user is moving, the visibility control unit does not start the visibility control.

6. The information processing device according to claim 4, wherein in the visibility control, as a speed of the sensed movement of the head of the user increases, the visibility control unit increases a speed in reducing the visibility of the second view.

7. The information processing device according to claim 4, wherein the visibility control unit performs the visibility control on a cover portion covering the view of the user.

8. The information processing device according to claim 7, wherein
the cover portion includes a see-through display and a light control unit, and
in the visibility control, the visibility control unit controls the light control unit such that transmittance of an area corresponding to the second view in the see-through display gradually decreases.

9. The information processing device according to claim 7, wherein
the cover portion includes a display unit, and
in the visibility control, the visibility control unit gradually changes a display color such that the display color in a display range corresponding to the second view in the display unit becomes a predetermined color.

10. The information processing device according to claim 7, wherein
the cover portion includes a display unit, and
in the visibility control, the visibility control unit gradually reduces luminance or resolution in a display range corresponding to the second view in the display unit.

11. The information processing device according to claim 7, wherein
the information processing device is a head-mounted device, and
the information processing device further includes the cover portion.

12. The information processing device according to claim 2, wherein the position of interest estimation unit estimates a position of an object identified on a basis of a sight line direction of the user detected by a sight line recognition unit as the position of interest of the user.

13. The information processing device according to claim 2, wherein in a case where a sound related to the user is generated, the position of interest estimation unit estimates a position corresponding to a generation source of the sound as the position of interest of the user.

14. The information processing device according to claim 2, wherein the position of interest estimation unit estimates, as the position of interest of the user, a position of an object in which the user is estimated to be interested in a real space in which the user is positioned or in a virtual space corresponding to virtual reality content the user is using.

15. The information processing device according to claim 12, wherein the visibility control unit performs the visibility control on a basis of a difference between the sight line direction of the user and a front direction of the user.

16. The information processing device according to claim 15, wherein
in a case where the difference between the sight line direction of the user and the front direction of the user is greater than a predetermined threshold, the visibility control unit performs the visibility control, and
in a case where the difference between the sight line direction of the user and the front direction of the user is equal to or less than the predetermined threshold, the visibility control unit inhibits performance of the visibility control.

17. The information processing device according to claim 16, wherein
the first view is a view corresponding to the sight line direction of the user, and
the visibility control unit further performs the visibility control on a basis of whether or not a plurality of virtual objects is positioned in the first view.

18. The information processing device according to claim 17, wherein
in a case where the plurality of virtual objects is positioned in the first view, the visibility control unit performs the visibility control, and
in a case where the plurality of virtual objects is not positioned in the first view, the visibility control unit inhibits performance of the visibility control.

19. An information processing method comprising:
estimating a position of interest of a user; and
performing, by a processor, visibility control to gradually reduce visibility of a second view opposite to a first view of the user corresponding to the position of interest such that the visibility of the second view of the user becomes lower than visibility of the first view.

20. A program for causing a computer to function as:
a position of interest estimation unit configured to estimate a position of interest of a user; and
a visibility control unit configured to perform visibility control to gradually reduce visibility of a second view opposite to a first view of the user corresponding to the position of interest such that the visibility of the second view of the user becomes lower than visibility of the first view.
